(19) United States
(12) Patent Application Publication
(10) Pub. No.: US 2018/0251183 A1
(43) Pub. Date: Sep. 6, 2018

(54) DISPLAY AND/OPERATING UNIT FOR A VEHICLE, IN PARTICULAR A BICYCLE OR LIGHTWEIGHT ELECTRIC VEHICLE

(71) Applicant: BLOKS. AG, Schaan (LI)

(72) Inventor: Daniel MEERMANN, München (DE)

(73) Assignee: BLOKS. AG, Schaan (LI)

(21) Appl. No.: 15/754,879

(22) PCT Filed: Aug. 26, 2016
(86) PCT No.: PCT/EP2016/070232

§ 371 Date: Feb. 23, 2018

(30) Foreign Application Priority Data
Aug. 26, 2015 (DE) 10 2015 216 338.5

(51) Int. Cl. B62K 11/14; B62K 23/02; B62M 6/80; G01S 7/02

(52) U.S. Cl. CPC B62K 11/14; B62K 23/02; B62J 2099/0013; G01S 7/022; B62M 6/80

(57) ABSTRACT

A display and operating unit (1) for a vehicle, in particular a conventional bicycle or a light electric vehicle such as an e-bike or an electric scooter, comprises a display device (2) that is configured to display information about an operating state of an electronic component of the vehicle, a first operating element (3) for manipulating the operating state of the electronic component in response to operation of the first operating element (3), and a second operating element (4) for manipulating a display of a display device (21) of a display and operating device (20) that is separate from the display and operating unit (1) in response to operation of the second operating element (4).

The present invention relates to a display and operating unit for a vehicle, in particular for a bicycle or a lightweight electric vehicle such as an e-bike or an electric scooter.

It is an object of the invention to provide a display and operating unit for a vehicle that affords the user improved ease of use and contributes to enhancing traffic safety.

This object is achieved by a display and operating unit for a vehicle according to claim 1.

Further preferred embodiments of the invention can be gathered from the dependent claims.

A display and operating unit for a vehicle, in particular a conventional bicycle or light electric vehicle such as an e-bike or electric scooter, comprises a display device configured to display information about an operating state of an electronic component of the vehicle, a first operating element for manipulating the operating state of the electronic component in response to operation of the first operating element, and a second operating element for manipulating a display of a display and operating device separate from the display and operating unit in response to operation of the second operating element.

When the display and operating unit according to the invention is arranged near the handle grip of the vehicle, setting of adjustable functions requires less attention on the part of the user. It is therefore possible for the user, for example, also when setting or manipulating adjustable functions of electronic components of the vehicle or manipulating the display of the display and operating device, to concentrate better on the traffic since he does not have to take his hand off the grip or handlebar.

This therefore enhances traffic safety, since the operation can be carried out using a finger, such as the thumb, without the hand being taken, for example, off a handlebar of an e-bike.

Furthermore, less space for arrangement of switches or push buttons or a smaller number of switches is required since many functions can be controlled by navigating the menu of the second operating element, which is designed, for example, as a touch-sensitive touchscreen. In addition, a clear design of adjustable functions can be realized by means of a menu-driven display with minimal expense on switches.

On account of a clear assignment of the first or second operating element on the handlebar to individual functionalities it is no longer necessary, for example, to arrange the operating elements around a display device.

According to one embodiment, the display and operating unit is pivotably mounted, wherein the display and operating unit is configured such that, in response to operation of the first operating element, a switch is activated that can be activated by a pivoting movement of the display and operating unit in order to manipulate the operating state of the electronic components. Further, the display and operating unit may comprise a touchscreen, wherein the second operating element is formed by a button on the touchscreen and it is possible to manipulate the display of the display device of the separate display and operating device by operating the button.

On account of this design of the first operating element as a rocker push-button and the design of the second operating element as a touchscreen, activation of the first operating element is haptically distinguishable from that of the touch-sensitive second operating element.

This also allows integration in the display and operating unit of multiple functions on the integrated, touch-sensitive display device, such as the touchscreen or another comparable display device, and possibly on another, external display device for dynamic presentation of information.

The display and operating unit according to the invention can be designed to be fastened on a fastening portion of the vehicle, and in particular have a surface that is slightly curved in accordance with the fastening portion and that faces away from the vehicle fastening portion to which the display and operating unit is fastened. In this way, for example, both the first operating element and the second operating element can be easily operated using the thumb when the display and operating unit is mounted close to a handle grip.

Furthermore, another surface of the display and operating unit, which in the fastened state is designed to face a portion of the vehicle, such as a handlebar of a conventional bicycle or lightweight electric vehicle such as an electric bicycle or electric scooter, likewise can have a slightly curved surface in order for the display and operating unit to be more easily mounted on a handlebar tube having a curved crosssection.

Preferably, the display and operating unit further comprises a detection device that is configured to separately detect a respective operation or actuation of the first operating element and of the second operating element, and if operation of both the first operating element and the second operating element is detected within a predetermined period, to ignore the detection of the operation of the second operating element.

This can prevent a switching operation being initiated by unintended user operation or activation.

The display and operating unit may further comprise a communication device configured to send electrical signals or radio signals to the electronic component in response to operation of the first operating element, to receive electrical signals or radio signals from the electronic component, and to send electrical signals or radio signals to the display and operating device in response to operation of the second operating element.

An arrangement according to one embodiment comprises a display and operating unit according to one of the embodiments described above and a display and operating device separate from the display and operating unit, wherein the display and operating unit is configured to send data to the display and operating device in response to operation of the first operating element, and the display and operating device being configured to receive the data sent by the display and operating unit and, based on the data received, change the display on the display device.

The display and operating unit can be configured to send data directly to the display and operating device in response to operation of the first operating element.

In another embodiment, the arrangement comprises an electronic control unit separate from the display and operating unit and the display and operating device for controlling an electronic component of a vehicle and for receiving data relating to an operating state of the electronic component, wherein the display and operating unit is configured to receive data from the electronic control unit and send data to the electronic control unit, and to display information on the display device based on the data received from the electronic control unit, and the display and operating device is configured to receive data from the electronic control unit and send data to the electronic control unit and, based on the data received from the electronic control unit, display information on the display device.

Below, an embodiment of a display and operating unit is described in further detail with reference to the accompanying drawings, in which:

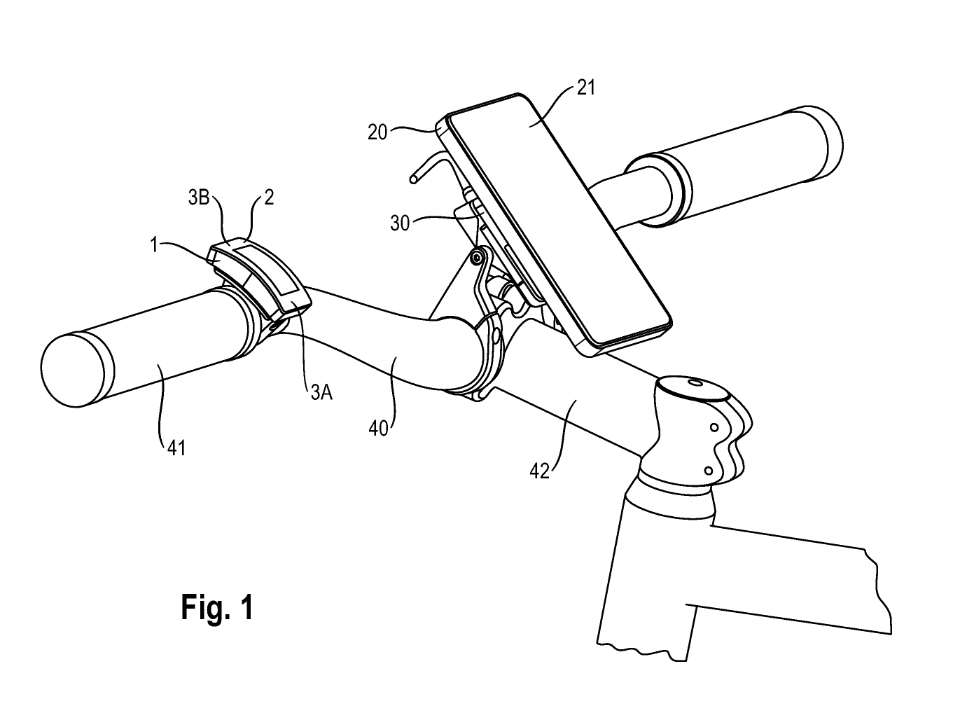

FIG. 1 is a perspective view of a display and operating unit according to an embodiment together with a separate display and operating device,

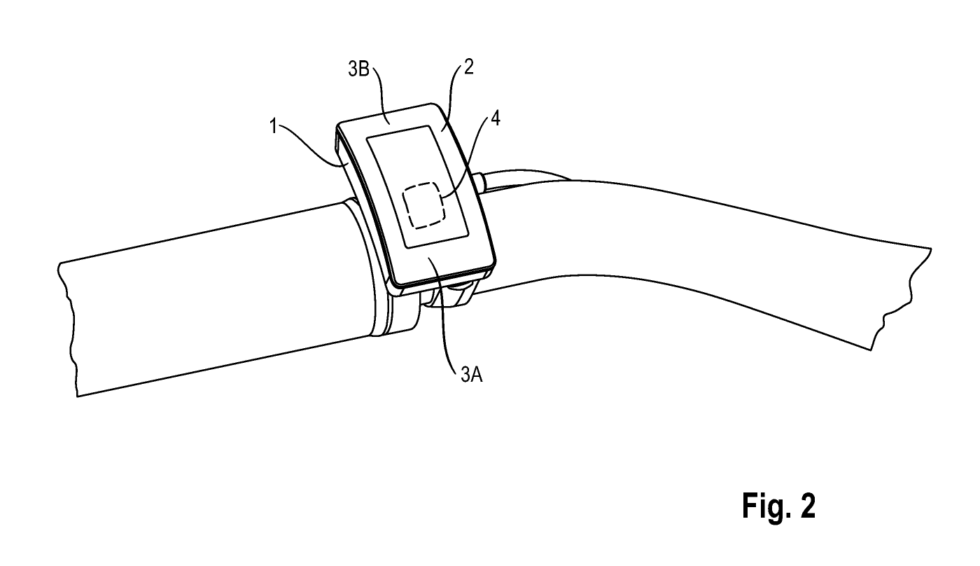

FIG. 2 is a view of the display and operating unit shown in FIG. 1, and

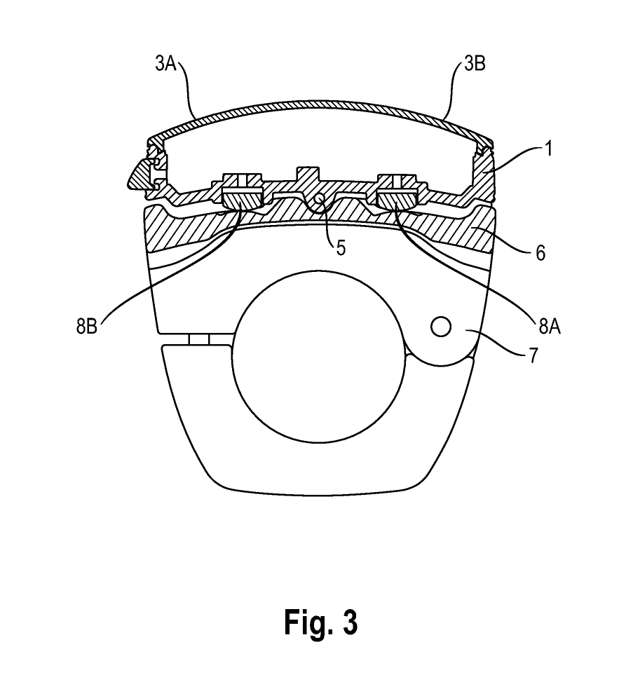

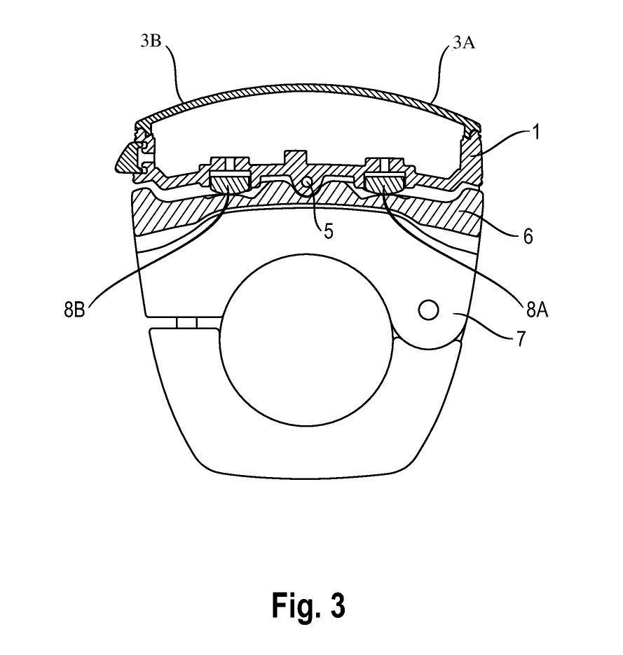

FIG. 3 is a cross-sectional view of the display and operating unit shown in FIG. 2.

FIG. 1 illustrates a display and operating unit 1 according to an embodiment together with a separately provided display and operating device 20, and FIG. 2 illustrates only the display and operating unit 1.

The display and operating unit 1 is configured for use in a vehicle, in particular a conventional bicycle or a light electric vehicle such as an e-bike or electric bicycle or an electric scooter or similar vehicle. The display and operating unit 1 is designed to be mounted on a portion of the vehicle and is preferably provided on a portion of a vehicle handlebar 40 near the grip 41 of the handlebar 40 such that the display and operating unit 1 can be operated by a user without them having to take their hand off the grip 41.

The display and operating device 20 is a part that is different and provided separately from the part forming the display and operating unit 1. The display and operating device 20 may be arranged, for example, in such a way on the handlebar 40 that it is located above or atop the stem 42 for the handlebar 40.

The display and operating unit 1 has a display device 2, configured to display information about an operating state of an electronic component of the vehicle (not shown). The electronic component can be, for example, an electric motor for providing a support drive that drives a wheel of the vehicle directly or indirectly, for example via a gear. Information about a degree of support in percentage of the maximum possible support by the electric motor can be displayed on the display device 2, for example.

Furthermore, the electronic component can be a component of an electronic gearshift in which the gears of the vehicle can be switched based on electrical signals. In this case, for example, information about a currently engaged gear can be displayed on the display device 2.

The display and operating unit 1 has a first operating element 3 or two first operating elements 3A, 3B for manipulating the operating state of the electronic component in response to operation or activation of the first operating element 3. By means of the operating element 3, preferably designed as a rocker push-button, both discrete and continuous settings of the operating state can be varied. With reference to FIG. 3, the display and operating unit 1 is in particular mounted so as to be pivotable about a shaft 5 that is supported on a base plate 6 of the display and operating unit 1 that is fastened to a clamp device 7 for fastening the display and operating unit 1 to the handlebar 40.

If by means of operation by the user, for example by pressing on operating element 3A, the display and operating unit 1 is pivoted about the shaft 5 in a clockwise direction when viewed in the drawing plane of FIG. 3, a for example spring-loaded push button 8A is activated by contact with the base plate 6 and pushed upward, initiating a switching operation of a switch (not shown) in order to manipulate the operating state of the electronic component.

By contrast, if by means of operation by the user, for example by pressing on the operating element 3B, the display and operating unit 1 is pivoted about the shaft 5 in a counterclockwise direction when viewed in the drawing plane of FIG. 3, a for example spring-loaded push button 8B is activated by contact with the base plate 6 and pushed upward, initiating a switching operation of a switch (not shown) in order to manipulate the operating state of the electronic component.

If the electronic component is the electric motor, then, for example, by pivoting the display and operating unit 1 clockwise, the support provided by the electric motor can be reduced, whereas by pivoting the display and operating unit 1 counterclockwise, the support provided by the electric motor is increased.

If the electronic component is the component of the electronic circuitry, then, for example, by pivoting the display and operating unit 1 clockwise, it is possible to switch down one gear, whereas pivoting the display and operating unit 1 counterclockwise switches up by one gear.

The display and operating unit 1 also has a second operating element 4 for manipulating a display of a display device 21 of the display and operating device 20 in response to the operation or activation of the second operating element 4 by the user.

The display and operating unit 1 can have a touchscreen, wherein the second operating element 4 is formed by a portion of the touchscreen, in particular by a button of the touchscreen. Given a predetermined manipulation of the touchscreen, in particular the button 4 of the touchscreen, by the user, such as swiping the touchscreen or pressing the button 4 twice in short succession, a function of the display and operating unit 1 is activated by means of which the display of the display device 21 of the separately provided display and operating device 20 can be manipulated by a further manipulation of the touchscreen of the display device 2.

For example, the further manipulation of the display of the separately provided display and operating device 20 can comprise an enlargement of the display of the display device 21 in response to two fingers spreading apart on the touchscreen.

Other functions of the display change can be made on the display of display device 21 by other corresponding manipulations of the touchscreen.

The display and operating unit 1 also has a detection device (not shown), such as a CPU, that is configured to detect an operation of the first operating element 3 and an operation of the second operating element 4 by the user. The detection device is preferably designed such that if operation of both the first operating element 3 and second operating element 4 is detected within a predetermined time period, the detection of the operation of the second operating element 4 is ignored and only one switching operation is performed in response to the operation of the first operating element 3. This can prevent a switching operation from being initiated by unintended user operation or activation.

Furthermore, the display and operating unit 1 comprises a communication device (not shown) that is configured to send electrical signals or radio signals to the electronic component in response to the operation of the first operating element 3, receive electrical signals or radio signals from the electronic component, send electrical signals or radio signals to the display and operating device 20 in response to the operation of the second operating element 4, and receive electrical signals or radio signals from the display and operating device 20.

The signals for manipulating the display and operating device 20 can be sent directly to the display and operating device 20 from the display and operating unit 1.

In another case, a separately provided electronic control unit 30 may be additionally provided for controlling electronic components of the vehicle and receiving data relating to an operating state of the electronic components, wherein the signals for manipulating the display and operating device 20 first are sent by the display and operating unit 1 to the electronic control unit 30 and possibly forwarded thereby after a check to the display and operating device 20.

In addition, the signals for manipulating the operating state of the electronic component can be sent from the display and operating unit 1 directly to the electronic component, and signals relating to the operating state of the electronic component can be received directly thereby.

In another embodiment, the signals for manipulating the operating state of the electronic component can first be sent by the display and operating unit 1 to the electronic control unit 30, and possibly forwarded thereby after a check to the electronic components. Furthermore, the signals or data relating to the operating state of the electronic component that are sent by the electronic component can first be received by the electronic control unit 30 and then forwarded to the display and operating unit 1.

Furthermore, in an embodiment not shown, further operating elements can be provided on the display and operating unit 1 in addition to first operating element 3 and second operating element 4.

1-8. (canceled)

9. A display and operating unit (1) for a vehicle, in particular a conventional bicycle or a light electric vehicle such as an e-bike or an electric scooter, comprising
a display device (2) that is configured to display information about an operating state of an electronic component of the vehicle,
a first operating element (3A, 3B) for manipulating the operating state of the electronic component in response to operation of the first operating element (3A, 3B), and
a second operating element (4) for manipulating a display of a display device (21) of a display and operating device (20) that is separate from the display and operating unit (1) in response to operation of the second operating element (4), wherein the display and operating unit (1) is pivotably mounted,
the display and operating unit (1) is configured such that a switch that can be activated by a pivoting movement of the display and operating unit (1) is activated in response to operation of the first operating element (3A, 3B) in order to manipulate the operating state of the electronic component, and wherein the display and operating unit (1) comprises a touchscreen (2), the second operating element (4) is formed by a button (4) of the touchscreen, and the display of the display device (21) of the separate display and operating device (20) can be manipulated by operation of the button (4).

10. The display and operating unit (1) according to claim 9, further comprising a detection device that is configured to separately detect a respective operation of the first operating element (3A, 3B) and the second operating element (4), and if operation of both the first operating element (3A, 3B) and second operating element (4) is detected within a predetermined period, to ignore the detection of the operation of the second operating element (4).

11. The display and operating unit (1) according to claim 9, further comprising a communication device that is configured to send electrical signals or radio signals to the electronic component in response to operation of the first operating element (3A, 3B), receive electrical signals or radio signals from the electronic component, and send electrical signals or radio signals to the display and operating device (20) in response to operation of the second operating element (4).

12. An arrangement comprising a display and operating unit (1) according to claim 9 and a display and operating device (20) that is separate from the display and operating unit (1), wherein the display and operating unit (1) is configured to send data to the display and operating device (20) in response to operation of the first operating element (3A, 3B), and the display and operating device (20) is configured to receive the data sent by the display and operating unit (1) and, based on the data received, change the display on the display device (21).

13. The arrangement according to claim 12, wherein the display and operating unit (1) is configured to send data directly to the display and operating device (20) in response to operation of the first operating element (3A, 3B).

14. The arrangement according to claim 12, further comprising an electronic control unit (30) that is separate from the display and operating unit (1) and the display and operating device (20) for controlling an electronic component of a vehicle and for receiving data relating to an operating state of the electronic component, wherein
the display and operating unit (1) is configured to receive data from the electronic control unit (30) and send data to the electronic control unit (30), and to display information on the display device (2) based on the data received from the electronic control unit (30), and
the display and operating device (20) is configured to receive data from the electronic control unit (30) and send data to the electronic control unit (30), and to display information on the display device (21) based on the data received from the electronic control unit (30).
